(19) United States
(12) Patent Application Publication
(10) Pub. No.: US 2026/0132062 A1
(43) Pub. Date: May 14, 2026

(54) SIMULTANEOUS CONTROL OF SCALE, CORROSION, AND HYDROGEN SULFIDE-RELATED ISSUES USING A SINGLE PRODUCT

(71) Applicant: ChampionX LLC, Sugar Land, TX (US)

(72) Inventors: Subhasis DE, Sugar Land, TX (US); John Paul SALCIDO, Pecos, TX (US); Miranda Jocelynn LOZOYA, Friendswood, TX (US); Donald BAEZA, Midland, TX (US)

(73) Assignee: ChampionX LLC, Sugar Land, TX (US)

(21) Appl. No.: 19/386,905

(22) Filed: Nov. 12, 2025

Related U.S. Application Data
(60) Provisional application No. 63/719,812, filed on Nov. 13, 2024.

(51) Int. Cl. C02F 1/68; C02F 5/14; C02F 103/10

(52) U.S. Cl. CPC C02F 1/683; C02F 5/14; C02F 2103/10; C02F 2303/08

(57) ABSTRACT

The present disclosure relates to methods and compositions for addressing problems that may arise in oil and gas operations. The compositions include multiple components and they may be used in methods of controlling, for example, corrosion, scale, and/or sulfur-containing components in oil and gas operations. A composition may include from about 0.1 wt. % to about 90 wt. % of a solvent, from about 0.1 wt. % to about 90 wt. % of a corrosion inhibitor, from about 0.1 wt. % to about 90 wt. % of a scale inhibitor, and from about 0.1 wt. % to about 90 wt. % of a scavenger.

### TECHNICAL FIELD

The present disclosure generally relates to methods and compositions for addressing problems that may arise in oil and gas operations. More particularly, the disclosure relates to compositions comprising multiple components that may be used in methods of controlling corrosion, scale, and hydrogen sulfide and/or a thiol in oil and gas operations.

### BACKGROUND

Combination products are a necessity for application within oil and gas production for multiple issues including scale, corrosion, paraffin, and solids, such as iron. However, combinatorial products including hydrogen sulfide scavenging chemistries have limited success thus far due to formulation as well as application challenges. For example, limited availability of injection points, especially for sour wells, to apply chemicals effectively for control of corrosion, scale and hydrogen sulfide-related issues (downhole as well as topside) poses operational challenges. Also, formulating these types of multicomponent products is very challenging due to the potential inherent incompatibilities among different components, which ultimately does not allow such products to function properly. Currently, therefore, operators tend to add the scavengers, corrosion inhibitors, and scale inhibitors separately or perhaps as a dual combination product, such as a product including a corrosion inhibitor and a scale inhibitor.

Commonly used amine formaldehyde adducts based hydrogen sulfide scavengers (such as triazine, hemi-formal, etc.) for oil and gas field applications typically work well at higher pH ranges (such as 8 or higher). At such high pH conditions, mercapto (SH⁻) ion is first formed in situ, which reacts nucleophilically with the respective scavenger chemistry. However, such high pH is not suitable for scale and corrosion inhibitors to function properly. At higher pH, neat product may induce localized scale formation with the produced fluid or increase the chances of corrosion towards a range of materials that are being used within oil and gas pipeline systems, downhole tubulars, and other equipment.

### BRIEF SUMMARY

The present disclosure provides compositions comprising multiple components that may be used in methods for controlling corrosion, scale, and hydrogen sulfide and/or a thiol in oil and gas operations.

In some embodiments, the present disclosure provides a method of treating a medium in a hydrocarbon production process. The method comprises adding a composition to the medium, wherein the composition comprises from about 0.1 wt. % to about 90 wt. % of a solvent, from about 0.1 wt. % to about 90 wt. % of a corrosion inhibitor, from about 0.1 wt. % to about 90 wt. % of a scale inhibitor, and from about 0.1 wt. % to about 90 wt. % of a scavenger.

In some embodiments, a composition of the present disclosure comprises from about 0.1 wt. % to about 90 wt. % of a solvent, from about 0.1 wt. % to about 90 wt. % of a corrosion inhibitor, from about 0.1 wt. % to about 90 wt. % of a scale inhibitor, and from about 0.1 wt. % to about 90 wt. % of a scavenger.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIGS. 1-4 show a listing of various compositions including solvents, scale inhibitors, corrosion inhibitors, and scavengers;

FIGS. 5-8 show corrosion control data for various compositions of the present disclosure.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, organic, inorganic, and/or functionally modified. A polymer of the present disclosure can be in the form of a solution, a dry powder, a liquid, or a dispersion, for example.

The present disclosure relates to corrosion inhibitor compounds, compositions, and methods of inhibiting corrosion. Inhibiting corrosion includes, for example, reducing corrosion, completely eliminating corrosion or prohibiting corrosion from occurring for some period of time, lowering a rate of corrosion, etc.

The present disclosure also relates to scale inhibitor compounds, compositions, and methods of inhibiting scale formation. Inhibiting scale formation includes, for example, reducing scaling, completely eliminating scaling or prohibiting scaling from occurring for some period of time, lowering a rate of scaling, etc.

The present disclosure further relates to scavenger compounds, such as hydrogen sulfide scavenger compounds, thiol scavenger compounds, and/or mercaptan scavenger compounds, compositions, and methods of scavenging hydrogen sulfide. Scavenging hydrogen sulfide includes, for example, reducing an amount of hydrogen sulfide in a medium or completely eliminating hydrogen sulfide from a medium.

The present disclosure provides compositions including a scavenger, a scale inhibitor, and a corrosion inhibitor. Such compositions can simultaneously address scale, corrosion, and hydrogen sulfide-related issues under different oil and gas field conditions. Formulating these types of multicomponent compositions is extremely challenging due to the potential inherent incompatibilities among different components, which ultimately do not allow such products to function properly.

The methods and compositions disclosed herein can remove significant amounts of hydrogen sulfide from a medium, such as a produced fluid, over a broad range of operating environments while maintaining corrosion and scale inhibition.

In accordance with certain aspects of the present disclosure, a composition is provided that includes from about 0.1 wt. % to about 90 wt. % of a solvent, from about 0.1 wt. % to about 90 wt. % of a corrosion inhibitor, from about 0.1 wt. % to about 90 wt. % of a scale inhibitor, and from about 0.1 wt. % to about 90 wt. % of a scavenger, such as a hydrogen sulfide scavenger.

The solvent is not particularly limited and may be selected from one or more of a polar protic solvent, an alcohol, methanol, isopropanol, a glycol, monoethylene glycol, ethylene glycol monobutyl ether, acetic acid, formic acid, water, and any combination thereof.

The amount of solvent in the composition in not particularly limited and may be, for example, from about 0.1 wt. % to about 90 wt. %, about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 0.1 wt. % to about 5 wt. %, about 0.1 wt. % to about 1 wt. %, about 1 wt. % to about 90 wt. %, about 5 wt. % to about 90 wt. %, about 10 wt. % to about 90 wt. %, about 20 wt. % to about 90 wt. %, about 30 wt. % to about 90 wt. %, about 40 wt. % to about 90 wt. %, about 50 wt. % to about 90 wt. %, about 60 wt. % to about 90 wt. %, about 70 wt. % to about 90 wt. %, or about 80 wt. % to about 90 wt. %.

In some embodiments, the composition comprises from about 5 wt. % to about 20 wt. % of the solvent.

The corrosion inhibitor is not particularly limited and may be selected from one or more of N-benzyl-alkylpyridinium chloride, benzyl quinolinium chloride, a fatty acid amine condensate (such as a reaction product of tall oil fatty acid with diethylenetriamine and acrylic acid), a quaternary ammonium compound (e.g., alkyldimethylbenzyl ammonium chloride), an organic sulfur compound (e.g., 2-mercaptoethanol), a substituted aromatic amine (such as an alkyl pyridine), a substituted alkyl amine (e.g., morpholine, triethanolamine), an ethoxylated branched nonylphenol phosphate (such as a phosphoric ester of nonylphenol ethoxylate), an oxyalkylated derivative (e.g., nonylphenyl polyethylene glycol), an anionic surfactant (such as dioctyl sodium sulfonsuccinate and dodecylbenzene sulfonic acid), a carboxylic acid derivative (such as 5(or 6)-carboxy-4-hexyl-2-cyclohexene-octanoic acid, tall-oil-maleated adduct), an imidazoline, and any combination thereof. In some embodiments, the corrosion inhibitor and/or the composition excludes an amine group.

The amount of corrosion inhibitor in the composition in not particularly limited and may be, for example, from about 0.1 wt. % to about 90 wt. %, about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 0.1 wt. % to about 5 wt. %, about 0.1 wt. % to about 1 wt. %, about 1 wt. % to about 90 wt. %, about 5 wt. % to about 90 wt. %, about 10 wt. % to about 90 wt. %, about 20 wt. % to about 90 wt. %, about 30 wt. % to about 90 wt. %, about 40 wt. % to about 90 wt. %, about 50 wt. % to about 90 wt. %, about 60 wt. % to about 90 wt. %, about 70 wt. % to about 90 wt. %, or about 80 wt. % to about 90 wt. %.

In some embodiments, the composition comprises from about 5 wt. % to about 20 wt. % of the corrosion inhibitor.

The scale inhibitor is not particularly limited and may be selected from one or more of an amine phosphonate, such as a ([2-(2-hydroxyethoxy)ethyl-(phosphonomethyl)amino]methylphosphonic acid or a salt thereof, bishexamethylenetriamine pentamethylenepentaphosphonic acid, diethylenetriaminepenta(methylenephosphonic acids or salts thereof), a sodium salt of a polyether phosphonomethylated amine, tetrasodium ethylenediaminetetraacetic acid, a maleicic acid polymer with sodium allylsulfonate, a polymer comprising vinylphosphonic acid and vinylsulfonic acid, a maleic acid and olefin polymer or a salt thereof (such as a sodium salt), and any combination thereof.

The amount of scale inhibitor in the composition in not particularly limited and may be, for example, from about 0.1 wt. % to about 90 wt. %, about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 0.1 wt. % to about 5 wt. %, about 0.1 wt. % to about 1 wt. %, about 1 wt. % to about 90 wt. %, about 5 wt. % to about 90 wt. %, about 10 wt. % to about 90 wt. %, about 20 wt. % to about 90 wt. %, about 30 wt. % to about 90 wt. %, about 40 wt. % to about 90 wt. %, about 50 wt. % to about 90 wt. %, about 60 wt. % to about 90 wt. %, about 70 wt. % to about 90 wt. %, or about 80 wt. % to about 90 wt. %.

In some embodiments, the composition comprises from about 1 wt. % to about 5 wt. % of the scale inhibitor.

The scavenger is not particularly limited and may be selected from one or more of a triazine, a reaction product of a hemiacetal and an amine, hexahydro-1,3,5-trimethyl-S-triazine (optionally combined with a quaternary ammonium compound), hexahydro-1,3,5-tris(2-hydroxyethyl)-S-triazine, and any combination thereof.

In some embodiments, the composition and/or the scavenger excludes an amine group.

In some embodiments, the scavenger comprises one or more of [nitrilotris(ethyleneoxy)]tri-methanol, methylenebis-methyloxazolidine, a substituted aliphatic aldehyde, such as glyoxal, 1,2-ethanediylbis(oxy))bismethanol, a substituted alkyl amine and formaldehyde adduct, an oxidant, inorganic peroxide, chlorine dioxide, glutaraldehyde, acrolein, methacrolein, and a metal-based scavenger, such as zinc bis(2-ethylhexanoate).

The amount of scavenger in the composition in not particularly limited and may be, for example, from about 0.1 wt. % to about 90 wt. %, about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 0.1 wt. % to about 5 wt. %, about 0.1 wt. % to about 1 wt. %, about 1 wt. % to about 90 wt. %, about 5 wt. % to about 90 wt. %, about 10 wt. % to about 90 wt. %, about 20 wt. % to about 90 wt. %, about 30 wt. % to about 90 wt. %, about 40 wt. % to about 90 wt. %, about 50 wt. % to about 90 wt. %, about 60 wt. % to about 90 wt. %, about 70 wt. % to about 90 wt. %, or about 80 wt. % to about 90 wt. %.

In some embodiments, the composition comprises from about 65 wt. % to about 90 wt. % of the scavenger.

In an illustrative, non-limiting example, a composition of the present disclosure comprises from about 5 wt. % to about 15 wt. % of the solvent, wherein the solvent comprises monoethylene glycol, from about 5 wt. % to about 15 wt. % of the corrosion inhibitor, wherein the corrosion inhibitor comprises a reaction product of tall oil fatty acid with diethylenetriamine and acrylic acid, alkyldimethylbenzyl ammonium chloride, 2-mercaptoethanol, triethanolamine, a phosphoric ester of nonylphenol ethoxylate, nonylphenyl polyethylene glycol, and any combination thereof, from about 1 wt. % to about 5 wt. % of the scale inhibitor, wherein the scale inhibitor is selected from the group consisting of tetrasodium ethylenediaminetetraacetic acid, diethylenetriaminepenta(methylenephosphonic acid) sodium salt, and any combination thereof, and from about 70 wt. % to about 90 wt. % of the scavenger, wherein the scavenger is selected from the group consisting of a reaction product of a hemiacetal and an amine, hexahydro-1,3,5-trimethyl-S-triazine, hexahydro-1,3,5-tris(2-hydroxyethyl)-S-triazine, and any combination thereof.

In an illustrative, non-limiting example, a composition of the present disclosure comprises from about 5 wt. % to about 15 wt. % of the solvent, wherein the solvent comprises monoethylene glycol, from about 5 wt. % to about 15 wt. % of the corrosion inhibitor, wherein the corrosion inhibitor comprises a reaction product of tall oil fatty acid with diethylenetriamine and acrylic acid, alkyldimethylbenzyl ammonium chloride, 2-mercaptoethanol, a phosphoric ester of nonylphenol ethoxylate, an alkyl pyridine, morpholine, dioctyl sodium sulfonsuccinate, and any combination thereof, from about 1 wt. % to about 5 wt. % of the scale inhibitor, wherein the scale inhibitor is selected from the group consisting of [2-(2-hydroxyethoxy)ethyl-(phosphonomethyl)amino]methylphosphonic acid, tetrasodium ethylenediaminetetraacetic acid, diethylenetriaminepenta(methylenephosphonic acid) sodium salt, and any combination thereof, and from about 70 wt. % to about 90 wt. % of the scavenger, wherein the scavenger is selected from the group consisting of a reaction product of a hemiacetal and an amine, hexahydro-1,3,5-trimethyl-S-triazine, hexahydro-1,3,5-tris(2-hydroxyethyl)-S-triazine, and any combination thereof.

In an illustrative, non-limiting example, a composition of the present disclosure comprises from about 10 wt. % to about 20 wt. % of the solvent, wherein the solvent comprises monoethylene glycol, isopropanol, methanol, or any combination thereof, from about 5 wt. % to about 15 wt. % of the corrosion inhibitor, wherein the corrosion inhibitor comprises a reaction product of tall oil fatty acid with diethylenetriamine and acrylic acid, alkyldimethylbenzyl ammonium chloride, 2-mercaptoethanol, triethanolamine, a phosphoric ester of nonylphenol ethoxylate, nonylphenyl polyethylene glycol, and any combination thereof, from about 1 wt. % to about 5 wt. % of the scale inhibitor, wherein the scale inhibitor is selected from the group consisting of tetrasodium ethylenediaminetetraacetic acid, diethylenetriaminepenta(methylenephosphonic acid) sodium salt, and any combination thereof, and from about 65 wt. % to about 75 wt. % of the scavenger, wherein the scavenger is selected from the group consisting of a reaction product of a hemiacetal and an amine.

In an illustrative, non-limiting example, a composition of the present disclosure comprises from about 5 wt. % to about 10 wt. % of the monoethylene glycol, from about 2 wt. % to about 4 wt. % of the reaction product of tall oil fatty acid with diethylenetriamine and acrylic acid, from about 1 wt. % to about 3 wt. % of the alkyldimethylbenzyl ammonium chloride, from about 0.5 wt. % to about 2 wt. % of the 2-mercaptoethanol, from about 1 wt. % to about 3 wt. % of the triethanolamine, from about 0.5 wt. % to about 2 wt. % of the phosphoric ester of nonylphenol ethoxylate, from about 0.5 wt. % to about 2 wt. % of the nonylphenyl polyethylene glycol, from about 0.5 wt. % to about 1.5 wt. % of the tetrasodium ethylenediaminetetraacetic acid, from about 2 wt. % to about 4 wt. % of the diethylenetriaminepenta(methylenephosphonic acid) sodium salt, and from about 75 wt. % to about 85 wt. % of the reaction product of the hemiacetal and the amine.

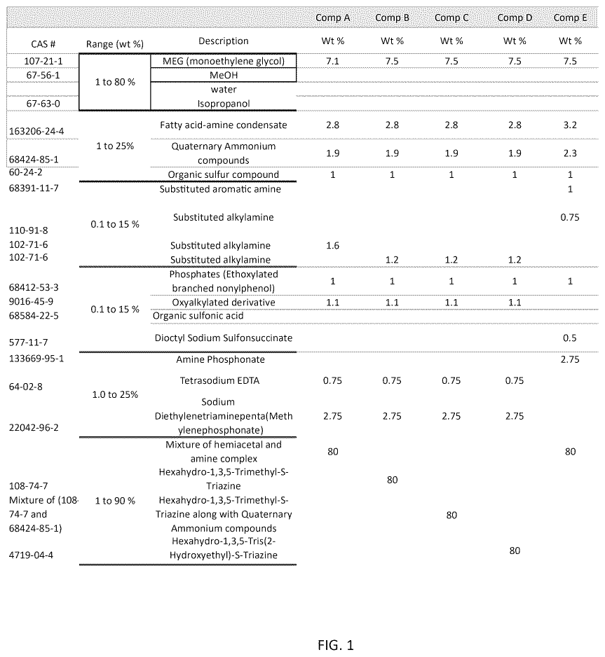

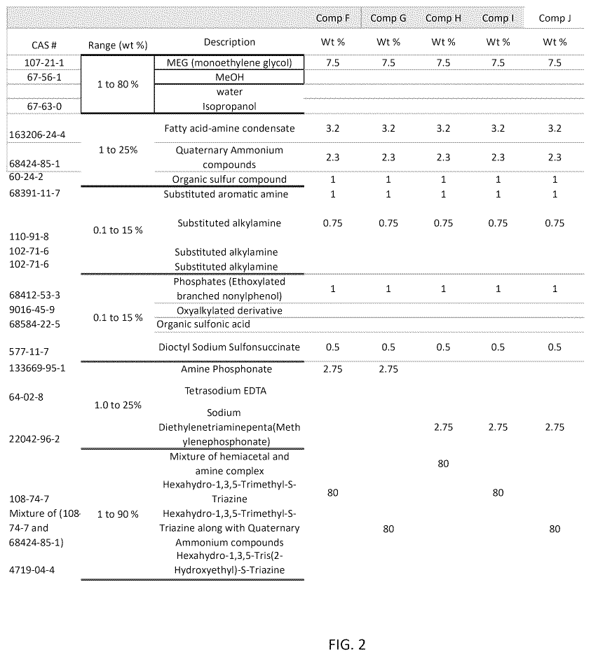

Additional examples of compositions of the present disclosure are provided in FIGS. 1-4. Experimental data showed that all of these compositions (except for COMP S-U) successfully achieved the goal of hydrogen sulfide, scale, and corrosion control. Compositions S-U were unable to achieve the goal, which further indicates that, in some embodiments, certain compounds and/or amounts of compounds are important to attain the beneficial technical effects of the present disclosure.

The compositions of the present disclosure may include (or exclude) one or more additional components (other than the corrosion inhibitor compound, scale inhibitor compound, scavenger, and solvent) and/or one or more additional components may be added to the medium before, after, and/or with a composition of the present disclosure.

Illustrative, non-limiting examples of additional components include a fouling control agent, an additional corrosion inhibitor, a corrosion inhibitor intensifier, a biocide, a preservative, an acid, an anti-emulsifier, an iron chelating agent, a surfactant, an asphaltene inhibitor, a paraffin inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, a clay stabilizer, a bactericide, a salt substitute, a relative permeability modifier, a breaker, a fluid loss control additive, an iron control agent, a drag reducing agent, a flow improver, a viscosity reducer, or any combination thereof.

A hydrate inhibitor may include, for example, a mono-alkyl amide, a di-alkyl amide, an alkyl quaternary ammonium salt, and any combination thereof.

An asphaltene inhibitor may include, for example, an alkylphenol/formaldehyde resin, a polyisobutylene esters, a polyisobutylene imides, a polyalkyl acrylate, and any combination thereof.

A paraffin inhibitor may include, for example, a polyalkyl acrylate, an olefin/maleic anhydride polymer, and any combination thereof.

A biocide may include, for example, glutaraldehyde, tetrakis(hydroxymethyl)phosphonium sulphate, a quaternary ammonium compound, chlorine, hypochlorite, ClO₂, bromine, ozone, hydrogen peroxide, peracetic acid, peroxycarboxylic acid, peroxysulphate, dibromonitrilopropionamide, isothiazolone, terbutylazine, polymeric biguanide, methylene bisthiocyanate, and any combination thereof.

The fouling control agent may comprise, for example, a quaternary compound.

The acid may comprise, for example, hydrochloric acid, hydrofluoric acid, citric acid, formic acid, acetic acid, or any combination thereof.

The additional corrosion inhibitor may comprise, for example, an imidazoline compound, a pyridinium compound, a quaternary ammonium compound, a phosphate ester, an amine, an amide, a carboxylic acid, a thiol, and any combination thereof.

The surfactant may be non-ionic, cationic, anionic, amphoteric, or zwitterionic.

In some embodiments, morpholine can act as passivator and thereby the overall product can be used for oxygen scavenging purposes. In some embodiments, triethanolamine in the formulation can be used for carbon capturing/carbon dioxide neutralization purposes. Similarly, EDTA has a strong affinity for iron and thus the product can be beneficial for controlling FeS-related issues.

The additional component may be added to the medium before, after, and/or with the composition of the present disclosure. The amount of additional component added to the medium is not particularly limited. For example, from about 1 ppm to about 5,000 ppm of the additional component may be added to the medium, such as about 1 ppm to about 2,500 ppm, about 1 ppm to about 2,000 ppm, about 1 ppm to about 1,500 ppm, about 1 ppm to about 1,000 ppm, about 1 ppm to about 750 ppm, about 1 ppm to about 500 ppm, about 1 ppm to about 250 ppm, about 1 ppm to about 100 ppm, about 25 ppm to about 5,000 ppm, about 25 ppm to about 2,500 ppm, about 25 ppm to about 1,500 ppm, about 25 ppm to about 1,000 ppm, or about 25 ppm to about 500 ppm.

If a composition of the present disclosure comprises the additional component, the composition may comprise from, for example, about 0.1 wt. % to about 25 wt. % of the component, such as from about 0.1 wt. % to about 20 wt. %, about 0.1 wt. % to about 15 wt. %, about 0.1 wt. % to about 10 wt. %, about 0.1 wt. % to about 5 wt. %, about 1 wt. % to about 5 wt. %, about 1 wt. % to about 10 wt. %, about 1 wt. % to about 15 wt. %, about 5 wt. % to about 15 wt. %, or about 5 wt. % to about 20 wt. %.

Any composition of the present disclosure may be in the form of, for example, a solution. A solution indicates that no suspended solids are present in the solvent. The components and/or the amounts of components (e.g., scavenger, scale inhibitor, corrosion inhibitor) may be carefully selected such that they do not interfere with each other, do not interfere with the intended function of each component (e.g., inhibit corrosion, inhibit scale, scavenge hydrogen sulfide), do not react with each other, do not “crash out” of the solvent, form solids in the solvent, etc.

The compositions of the present disclosure may be used in various methods/processes related to the oil and gas industry. For example, a method of the present disclosure may involve treating a medium in a hydrocarbon production process. The method may include adding one or more compositions as disclosed herein to the medium. The medium may contain various components, such as a thiol and/or hydrogen sulfide, a corrodent, and/or a component responsible for causing scale. The medium may be in contact with a metal surface susceptible of corrosion.

Once the compositions of the present disclosure are added to the medium, the corrosion inhibitor compound may contact the metal surface, form a barrier on the surface, and inhibit corrosion of the surface. Likewise, the scale inhibitor may inhibit the formation of scale on the metal surface or any surface in contact with the medium. Additionally, once the composition has been added to the medium, the scavenger may interact with and/or reduce an amount of hydrogen sulfide in the medium.

In some embodiments, the compositions, compounds, and methods of the present disclosure may be added to any medium present in an oil and/or gas production well/subterranean formation and/or pipeline. A composition may be applied to a gas or liquid medium produced or used in the production, transportation, storage, and/or separation of crude oil or natural gas.

The medium in which the compositions and/or compounds of the disclosure are introduced can be contained in and/or exposed to many different types of devices/components. For example, the medium may be contained in an apparatus that transports fluid or gas from one point to another, such as an oil and/or gas pipeline. The device/component may be part of an oil and/or gas refinery, such as a pipeline, a separation vessel, a dehydration unit, or a gas line. The medium may also be contained in and/or exposed to a device/component used in oil extraction and/or production, such as a wellhead.

In some embodiments, one or more of a pipeline, a heat exchanger, a storage vessel, a flowline, a downhole tubular, a casing, a tank (e.g., railroad tank car or a tank truck/tanker), a separator, or any combination thereof, comprises the medium and/or surface (e.g., metal surface).

In certain embodiments, a subterranean formation and/or a pipeline comprises the medium and/or surface (e.g., metal surface) to be treated by a composition and/or compound of the present disclosure. Certain methods disclosed herein comprise adding a composition and/or compound disclosed herein to a medium that comprises a metal surface.

The presently disclosed compositions, compounds, and methods are useful for inhibiting corrosion of surfaces comprising any metal or combination of metals. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen.

In some aspects of the present disclosure, a metal surface may comprise metallic-chrome steel, ferritic-alloy steel, austenitic-steel, precipitation-hardened steel, high-nickel steel, carbon steel, or a combination thereof.

A medium of the present disclosure may comprise a component selected from a metal cation, a metal complex, a metal chelate, an organometallic complex, an aluminum ion, an ammonium ion, a barium ion, a chromium ion, a cobalt ion, a cuprous ion, a cupric ion, a calcium ion, a ferrous ion, a ferric ion, a hydrogen ion, a magnesium ion, a manganese ion, a molybdenum ion, a nickel ion, a potassium ion, a sodium ion, a strontium ion, a titanium ion, a uranium ion, a vanadium ion, a zinc ion, a bromide ion, a carbonate ion, a chlorate ion, a chloride ion, a chlorite ion, a dithionate ion, a fluoride ion, a hypochlorite ion, an iodide ion, a nitrate ion, a nitrite ion, an oxide ion, a perchlorate ion, a peroxide ion, a phosphate ion, a phosphite ion, a sulfate ion, a sulfide ion, a sulfite ion, a hydrogen carbonate ion, a hydrogen phosphate ion, a hydrogen phosphite ion, a hydrogen sulfate ion, a hydrogen sulfite ion, an acid, a thiol, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, a polysaccharide, a metal oxide, sand, a clay, silicon dioxide, titanium dioxide, mud, a brine, an insoluble inorganic particulate, an insoluble organic particulate, an alcohol, and any combination thereof.

The medium is not particularly limited and may include, for example, produced water, fresh water, seawater, municipal water, recycled water, salt water, surface water, injection water, ground water, carbon dioxide, hydrogen, or any mixture thereof.

A medium may comprise, for example, water, gas, and/or a liquid hydrocarbon. The liquid hydrocarbon may be any type of liquid hydrocarbon including, but not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, and kerosene. The medium may also comprise a refined hydrocarbon product.

A medium (e.g., a fluid and/or a gas) treated with a composition and/or compound of the present disclosure can be at any selected temperature, such as ambient temperature or an elevated temperature. For example, the medium (e.g., water, liquid hydrocarbon, gas, etc.) may be at a temperature of from about 40° C. to about 250° C. In some embodiments, the medium may be at a temperature of from about −50° C. to about 300° C., about 0° C. to about 200° C., about 10° C. to about 100° C., or about 20° C. to about 90° C.

The amount of composition added to the medium is not particularly limited. The amount may be, for example, from about 1 ppm to about 10,000 ppm, such as from about 1 ppm to about 8,000 ppm, about 1 ppm to about 6,000 ppm, about 1 ppm to about 4,000 ppm, about 1 ppm to about 2,000 ppm, about 1 ppm to about 1,000 ppm, about 1 ppm to about 800 ppm, about 1 ppm to about 600 ppm, about 1 ppm to about 400 ppm, about 1 ppm to about 200 ppm, about 1 ppm to about 100 ppm, about 1 ppm to about 50 ppm, about 10 ppm to about 10,000 ppm, about 50 ppm to about 10,000 ppm, about 100 ppm to about 10,000 ppm, about 1,000 ppm to about 10,000 ppm, about 3,000 ppm to about 10,000 ppm, or about 5,000 ppm to about 10,000 ppm.

The compositions and/or compounds disclosed herein may be added to a medium and/or metal surface using a variety of different application methods known in the art. In some embodiments, the compositions and/or compounds may added continuously or intermittently to the medium, either automatically or manually, by using, for example, chemical injection pumps. The addition may involve dripping, pouring, spraying, pumping, injecting, or otherwise adding the composition, compound, and/or optional component to the medium and/or the metal surface. In certain embodiments, addition may be via gas lift and/or capillary-string. In some embodiments, the composition may be heated, such as from about 30° C. to 100° C., prior to addition.

The compositions and methods disclosed herein solve numerous problems in the art in addition to scale, corrosion, and hydrogen sulfide-related issues. The compositions and methods lower the overall carbon footprint of the process by minimizing shipment of various drums of separate chemicals (such as separate inhibitors, scavengers, etc.), the compositions may be applied via various application methods, such as gas lift, the components and/or amounts of components in the compositions can be adjusted to make them stable over a wide range of application temperatures, and the compositions can be applied in diluted or undiluted form, continuously or in batch method. Other logistical advantages are achieved by the compositions and methods disclosed herein, such as a reduction in the number of storage tanks, injection pumps, etc., needed in the field. Also, an overall reduction in the amount of solvent needed may be achieved by the compositions and methods disclosed herein.

The foregoing may be better understood by reference to the following examples, which are intended for illustrative purposes and are not intended to limit the scope of the disclosure or its application in any way.

### EXAMPLES

Three compositions were made for use in bottle tests.

Scavenger 1 was a commercial hydrogen sulfide scavenger including an amine complex, a hemiacetal, and methanol.

Exp1 comprised about a 1:1 weight ratio of Scavenger 1 to Comp 1, which was a composition comprising about 8 wt. % monoethylene glycol, about 4 wt. % methanol, about 59 wt. % water, about 6 wt. % of a fatty acid amine condensate, about 4 wt. % of a quaternary ammonium compound, about 2 wt. % of an organic sulfur compound, about 3 wt. % of a substituted alkylamine, about 2 wt. % of phosphates (ethoxylated branched nonylphenol), and about 2 wt. % of an oxyalkylated derivative.

Exp2 comprised about a 2:1 weight ratio of Scavenger 1 to Comp 1.

Bottles were dosed with the one of the compositions using a pipette. The bottles also included well fluids containing hydrogen sulfide. Each composition was tested with respect to 100 ml water phase and about 15 to 20 mL oil, i.e., about 120 mL total fluids. The samples were shaken 100 times to ensure contact time. Hydrogen sulfide was measured via a seal in the bottle opened by a puller. Results are shown in Table 1.

TABLE 1

| 100 ml Control + | | H2S | Micro | |
|---|---|---|---|---|
| Mixture | Sample Test | Measured | to ml | PPM |
| 0 | Blank test | 400 | 0 | 0 |
| 50 | Scavenger 1 | 200 | 0.05 | 500 |
| 100 | Scavenger 1 | 65 | 0.1 | 1000 |
| 150 | Scavenger 1 | 10 | 0.15 | 1500 |
| 0 | Blank test | 400 | 0 | 0 |
| 100 | EXP1 | 200 | 0.1 | 1000 |
| 200 | EXP1 | 40 | 0.2 | 2000 |
| 300 | EXP1 | 10 | 0.3 | 3000 |
| 0 | Blank test | 400 | 0 | 0 |
| 50 | EXP2 | 180 | 0.05 | 500 |
| 100 | EXP2 | 95 | 0.1 | 1000 |
| 150 | EXP2 | 42 | 0.15 | 1500 |

Next, a gunk test was performed to determine if the compositions of the present disclosure were suitable to be applied via gas lift lines where solvents and/or other volatile components may evaporate under simulated field conditions. The objective of this test was to determine how the chemical behaves or flows under conditions which may remove solvent, such as when a chemical is atomized into a flowing dry gas stream. A liquid is desired to allow chemical to flow and be co-injected along with the gas lift gas. Conversely, products that show high viscosity, solids, or precipitates could cause risk plugging of the gas lift injection mandrels.

The gunk test was conducted on a bench top rotary evaporator (rotovap) to remove low boiling solvents from a sample through evaporation. The product was added to a round bottom flask, attached to the rotovap unit, then submerged into a silicon oil bath. Approximately 50-100 g of the composition was weighed in the flask, and the test was performed at the application downhole temperatures near the gas lift injection point and vacuum applied (71° C. at 300 mbar) to simulate the gunking behavior. The test was carried out for 4 hours.

Once the test was complete, visual observations of the product were recorded, and photos of the flask were taken. The flask was weighed and the following equation was used to calculate the percent weight loss.

$$Weight Loss ( \% ) = \frac{( {W}_{flask + sample before test} ) - ( {W}_{flask + sample after test} )}{{W}_{sample}}$$

$${}^{*} Note : W indicates weight in grams$$

After four hours of testing at 71° C. and 300 mbar of absolute pressure, COMP A remained as a flowable liquid and no observation of instability, solids, precipitates, or gelling could be seen. Approximately 25% of product mass was lost during the test but the remaining liquid maintained excellent flowability. These observations show that COMP A passed the gunk test and is suitable for application up to about 71° C. Higher temperature applications may require additional testing.

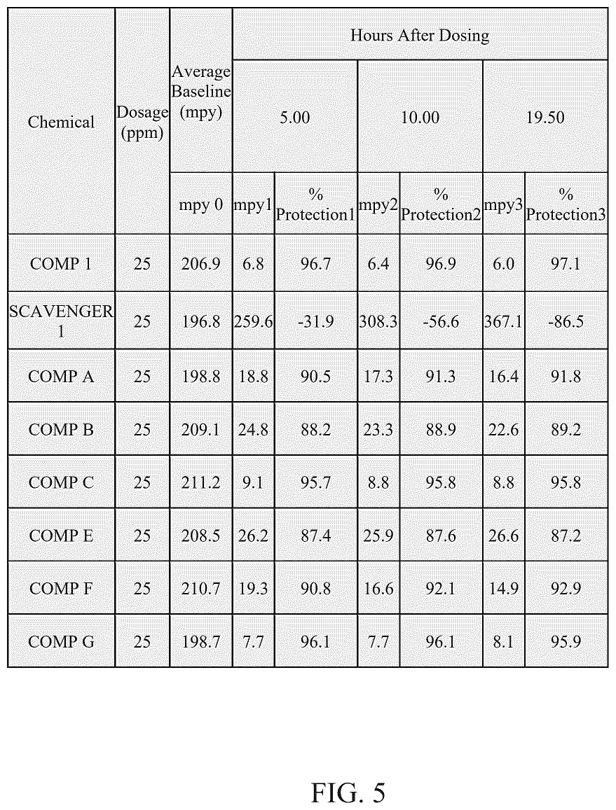

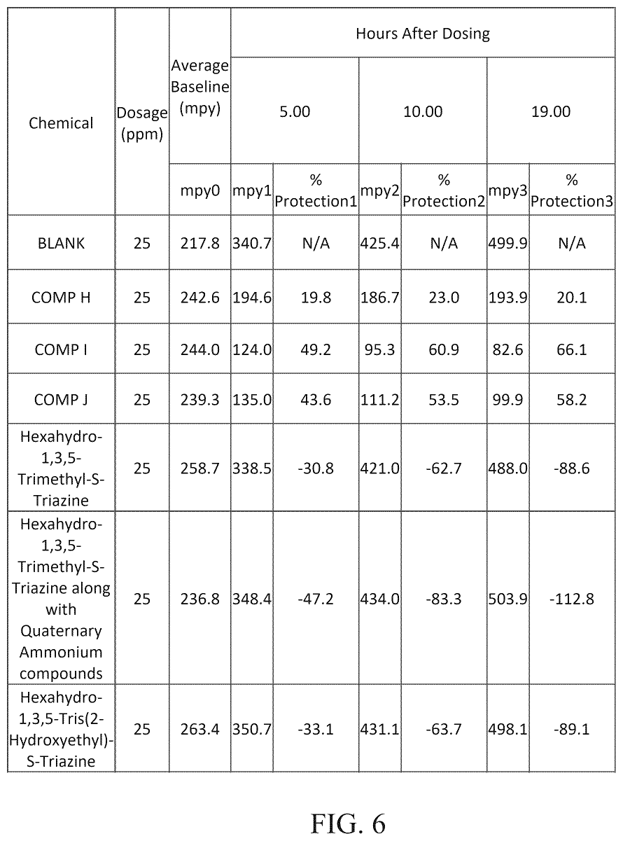

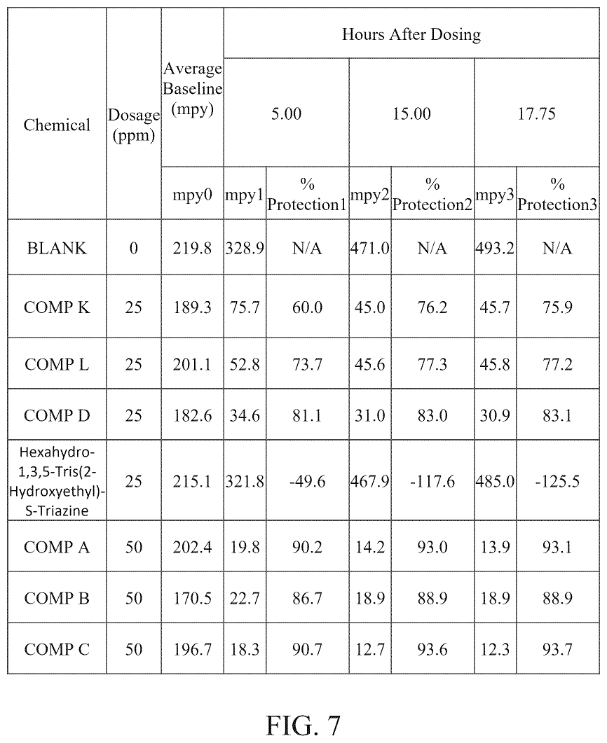

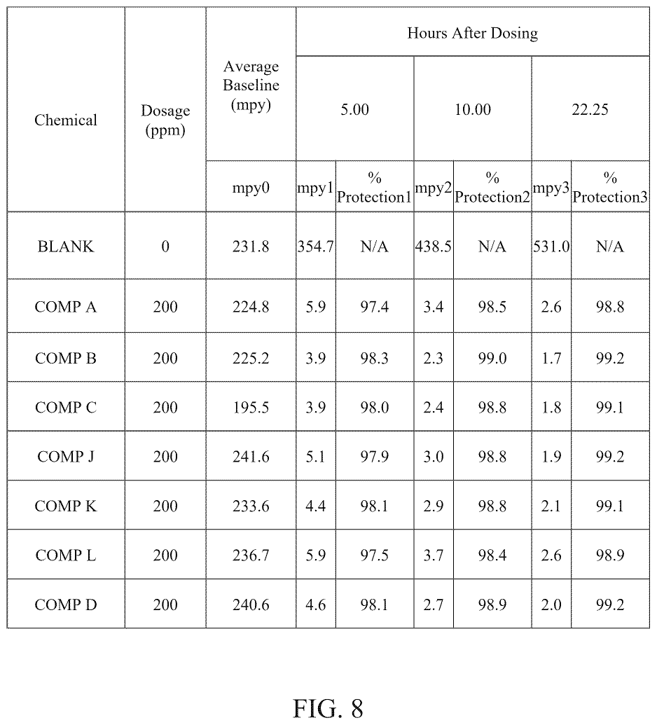

Bubble Cell testing was carried out to assess the corrosion performance of various compositions of the present disclosure. The tests were conducted at about 60° C. using a C-1018 steel coupon. A 3% NaCl brine was used along with a rotation speed of 100 rpm and a CO₂ sparge. The tests were run for about 16 to about 22 hours and the compositions were dosed at about 25 to about 200 ppm. Results can be seen in FIGS. 5-8.

In additional tests, compositions were tested for compatibility with representative fluids by evaluating heated produced water for product precipitation and phase separation. The compositions were also evaluated for their performance on calcite scales via the Dynamic Scale Loop and barite scales via a static bottle test.

To test the product compatibility with produced water when heated, about 100 mL of a brine (pH about 7) was added to a prescription bottle and dosed with a composition of the present disclosure at about 2,000 ppm. The bottles were then placed in an 80° C. water bath and left overnight. The next day, the bottles containing COMP E, COMP F, COMP G, COMP H, COMP I, COMP J, COMP A, COMP B, and COMP C were clear solutions with no solids formation, indicating stable mixtures.

To further test the product compatibility with brine when heated, about 100 mL of a brine obtained from the field (pH about 7) was added to a prescription bottle and dosed with COMP A at about 100 ppm, about 200 ppm, about 350 ppm, about 500 ppm, about 1,000 ppm, about 2,500 ppm, and about 10,000 ppm. The bottles were then placed in an 80° C. water bath for about 24 hours. All bottles contained clear solutions with no solids formation, indicating stable mixtures.

COMP A was evaluated for emulsion tendency in the presence of a brine/hydrocarbon composition. The composition met all evaluation criteria and exhibited a water/oil breakout time of less than 30 seconds, which was consistent with the control sample. This test was performed using actual field fluids (both water and oil).

Dynamic Scale Loop (DSL) was chosen as the method to determine scale inhibition properties of each composition. This test is widely used in the industry to determine the tendency of synthetic waters to form scale in a capillary at defined temperatures and pressures. The apparatus can also be used to determine the effectiveness of scale inhibiting additives. In addition, the minimum effective dose of inhibitors can be bracketed.

The DSL used was a high temperature/high pressure system operating with pressures up to 3,500 psi and temperatures up to 250° C. The DSL operates under the principle that as scale builds-up on the interior surface of the small metal capillary, a difference of pressure can be measured. A rapid pressure increase is indicative of severe scaling conditions. The DSL holds two sets of fluids contained in reservoirs on top of the unit. These are divided into the cationic and anionic brines. The cationic brine contains the scaling cations (Ca²⁺, Ba²⁺, Mg²⁺, etc.) of interest, while the anionic brine contains the scaling anions (SO₄²⁻, HCO₃⁻; etc.). The remaining ions of the brines are divided equally between the fluids to give them similar densities. The final mix of the two fluids results in the desired synthetic brine.

A typical scenario for a scaling tendency test and inhibitor evaluation is to prepare fluids, load into reservoirs on the top of the unit, set temperature and pressure parameters on the system, and begin flow of deionized water. The reference differential pressure across the capillary is noted with the DI water flow at a constant flow rate through both pumps. Fluid selection is switched to cation and anion brine and a timer started for a “blank” run with no inhibitor added. The time for the fluids to form enough scale deposit to produce a significant differential pressure increase above the reference pressure is recorded. The loop is then flushed with a cleaning agent to remove scale deposit from the coil, then flushed and reloaded with deionized water to completely remove any residual.

The inhibited fluids are then evaluated starting with a high concentration of inhibitor and reducing the concentration until a significant increase in differential pressure is observed. Each concentration is typically run 2 to 3 times the inhibited blank time. If the tested concentration does not meet the cut off pressure within the referenced scale time, the next dosage of inhibitor is evaluated until scaling is observed. The recommended minimum effective dosage (MED) is the lowest tested concentration with no increase in differential pressure after running 2 to 3 times the blank time.

While conducting the DSL tests, a temperature of about 176° F. was used in addition to a flow rate of about 10 ml/min. The scaling coil had a 1 mm inner diameter and was 100 cm in length. The system had a pressure of about 1,000 psi.

Under the testing parameters, a first brine showed a scaling time of 90 minutes and 85 minutes for two individual runs with no scale inhibitor and testing time for MED of inhibitors was set to 180 minutes to allow ample time for pressure increases inside the scaling coil to be observed. MEDs for certain compositions of the present disclosure can be seen in Table 2.

TABLE 2

| Product Name | Minimum Effective Dosage |
|---|---|
| COMP O | 25 ppm > 0 ppm |
| COMP P | 50 ppm > 25 ppm |
| COMP Q | 50 ppm > 25 ppm |
| COMP R | 75 ppm > 50 ppm |

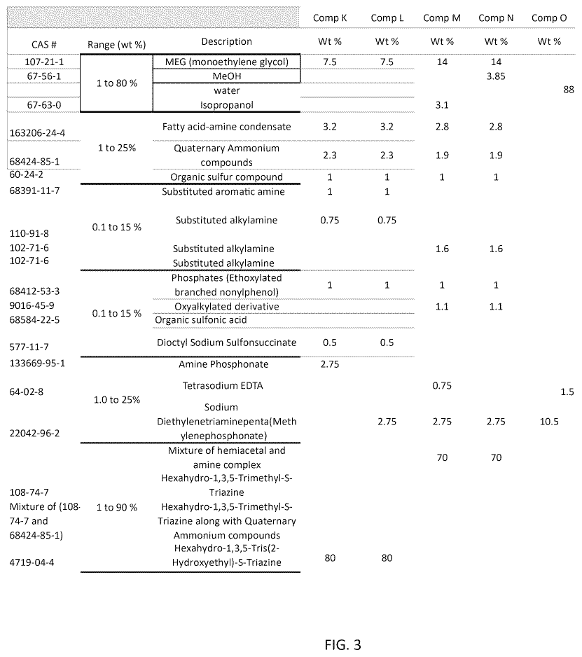

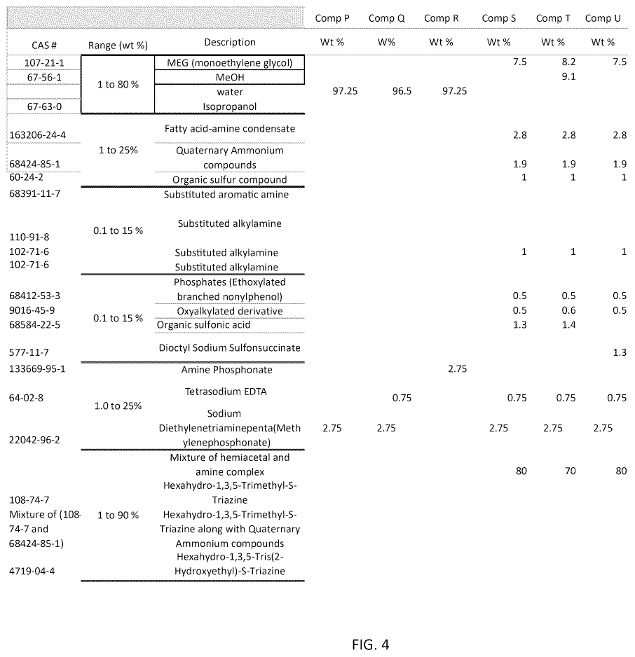

For the DSL testing, only the respective scale inhibitor compounds of each composition were tested. All other components and/or compounds of each composition shown in FIGS. 3 and 4 were excluded to avoid false positive results from the other surfactant-based components and/or compounds present in the compositions. The scale inhibitor compounds were dissolved in water in the concentrations shown in FIGS. 3 and 4. Accordingly, for the DSL testing, COMP O included water, about 1.5 wt. % tetrasodium EDTA, and about 10.5 wt. % diethylene triaminepenta(methylenephosphonate), COMP P included water and about 2.75 wt. % diethylene triaminepenta(methylenephosphonate), COMP Q included water, about 0.75 wt. % tetrasodium EDTA, and about 2.75 wt. % diethylene triaminepenta(methylenephosphonate), and COMP R included water and about 2.75 wt. % of amine phosphonate.

To carry out the static bottle testing, a brine was chosen to determine the minimum effective dose of the inventive compositions for barite scale. About 15 milliliters of the brine were pipetted into glass bottles. A composition of the present disclosure was added into each bottle at a dosage ranging from about 5 ppm to about 75 ppm, while one sample was left untreated (blank). After the bottles were dosed, an additional 15 milliliters of brine was added to the bottles. The samples were left in ambient temperature and allowed to react overnight.

The next day, 1 milliliter of supernate was syphoned from each sample and analyzed for cation content via inductively coupled plasma (ICP). The measured cation content of the treated samples was compared to the measured cation content of the cation brine (before mixing) and the untreated sample. Cation concentration of the solution will decrease as scale is precipitated inside the sample bottles with the untreated sample having the lowest amount of cation present in solution. Effectiveness of the scale inhibitor was quantified by percentage of cation remaining in solution. At about 50 ppm and about 75 ppm, COMP H, COMP I, COMP J, COMP A, COMP B, COMP C effectively controlled scale.

In a final series of tests, a dynamic vapor phase evaluation was conducted for various compositions of the present disclosure.

The objective of this procedure was to assess the performance of H₂S scavengers under a variety of conditions. The tests were designed to utilize soured fluids in a sealed vessel that have been agitated and heated for a predetermined amount of time, followed by the measurement of H₂S in the gaseous headspace above the soured fluids. The optimized vapor test provides a rapid screening method to determine vapor phase H₂S concentrations in aqueous and organic-based solvents. This is an ideal method for determining H₂S scavenger efficiency for the development of new high capacity H₂S scavenger additives. In addition, this method provides information on H₂S concentrations in crude oil, distillate fuels (diesel and jet) and bunker (residual) fuel oils at room temperature and ambient pressure. This evaluation is a modified version of ASTM D-5705 and utilizes ASTM D-4810.

A brief overview on the modified ASTM D-5705 procedure used is as follows: Soured hydrocarbon concentrate was added to a septum sealed bottle at the targeted water/oil cut (about 50 wt. %) via a dilution process to achieve the targeted H₂S level in the vapor space in an un-treated test. In the case of dosed tests, H₂S scavenger compositions of the present disclosure were pre-dosed into the bottle prior to the addition of sour concentrate. The sour test vessel was then placed into a pre-heated oven (about 165° F. to about 175° F.) where the fluids were agitated for a period (about 15 minutes) designed to simulate the residence time in the system. Upon completion of the test, the vessel was removed from the oven and the H₂S concentration in the vapor space of the vessel (above the oil/water mixture) was the measured by piercing the septum with a H₂S detection stain tube and pump. Results of the tests can be seen in the below Tables 4 and 5.

TABLE 4

| | | H2S | |
|---|---|---|---|
| | Dosage | Measured | % H2S |
| Product | (PPM) | PPM | Reduction |
| BLANK | 0 | 680 | 0 |
| Scavenger 1 | 200 | 180 | 73.53 |
| COMP A | 200 | 320 | 52.94 |
| COMP B | 200 | 50 | 92.65 |
| COMP C | 200 | 60 | 91.18 |
| COMP E | 200 | 360 | 47.06 |
| COMP F | 200 | 50 | 92.65 |
| COMP G | 200 | 60 | 91.18 |
| COMP H | 200 | 300 | 55.88 |
| COMP I | 200 | 50 | 92.65 |
| COMP J | 200 | 50 | 92.65 |

TABLE 5

| | | H2S | |
|---|---|---|---|
| | Dosage | Measured | % H2S |
| Product | (PPM) | PPM | Reduction |
| BLANK | 0 | 510 | 0 |
| Scavenger 1 | 500 | 25 | 95.10 |
| COMP A | 500 | 60 | 88.24 |
| COMP B | 500 | 20 | 96.08 |
| COMP C | 500 | 15 | 97.06 |
| COMP E | 500 | 80 | 84.31 |
| COMP F | 500 | 15 | 97.06 |
| COMP G | 500 | 20 | 96.08 |
| COMP H | 500 | 55 | 89.22 |
| COMP I | 500 | 20 | 96.08 |
| COMP J | 500 | 10 | 98.04 |

In view of the foregoing, it can be seen that the present disclosure provides compositions that can effectively address scale, corrosion, and hydrogen sulfide with specific properties to match the various field requirements, such as thermal stability, low emulsion tendency, improved oil/water separation, low viscosity for down-hole injection, gas lift and capillary string applicability, increased corrosion inhibitor film persistency, increased barium sulfate inhibition, and compatibility of the neat chemical with carbon steel or other low alloy containing metallurgy.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein. The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of treating a medium in a hydrocarbon production process, comprising:
adding a composition to the medium, wherein the composition comprises
from about 0.1 wt. % to about 90 wt. % of a solvent,
from about 0.1 wt. % to about 90 wt. % of a corrosion inhibitor,
from about 0.1 wt. % to about 90 wt. % of a scale inhibitor, and
from about 0.1 wt. % to about 90 wt. % of a scavenger.

2. The method of claim 1, wherein the medium comprises a component selected from the group consisting of a metal cation, a metal complex, a metal chelate, an organometallic complex, an aluminum ion, an ammonium ion, a barium ion, a chromium ion, a cobalt ion, a cuprous ion, a cupric ion, a calcium ion, a ferrous ion, a ferric ion, a hydrogen ion, a magnesium ion, a manganese ion, a molybdenum ion, a nickel ion, a potassium ion, a sodium ion, a strontium ion, a titanium ion, a uranium ion, a vanadium ion, a zinc ion, a bromide ion, a carbonate ion, a chlorate ion, a chloride ion, a chlorite ion, a dithionate ion, a fluoride ion, a hypochlorite ion, an iodide ion, a nitrate ion, a nitrite ion, an oxide ion, a perchlorate ion, a peroxide ion, a phosphate ion, a phosphite ion, a sulfate ion, a sulfide ion, a sulfite ion, a hydrogen carbonate ion, a hydrogen phosphate ion, a hydrogen phosphite ion, a hydrogen sulfate ion, a hydrogen sulfite ion, an acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, a polysaccharide, a metal oxide, sand, a clay, silicon dioxide, titanium dioxide, mud, a brine, an insoluble inorganic particulate, an insoluble organic particulate, an alcohol, and any combination thereof.

3. The method of claim 1, further comprising inhibiting corrosion of a metal surface in contact with the medium and/or inhibiting scale formation on a surface in contact with the medium.

4. The method of claim 3, wherein the metal surface and the surface are the same surface.

5. The method of claim 1, further comprising reducing an amount of hydrogen sulfide in the medium.

6. The method of claim 1, wherein the medium comprises produced water, fresh water, seawater, brackish water, recycled water, salt water, surface water, condensed water, injection water, ground water, carbon dioxide, hydrogen, or any mixture thereof.

7. The method of claim 3, wherein a subterranean formation and/or a pipeline comprises the metal surface and/or the surface.

8. The method of claim 1, wherein the solvent is selected from the group consisting of a polar protic solvent, an alcohol, water, a glycol ether, and any combination thereof.

9. The method of claim 1, wherein the corrosion inhibitor is selected from the group consisting of N-benzyl-alkylpyridinium chloride, benzyl quinolinium chloride, a fatty acid amine condensate, a quaternary ammonium compound, an organic sulfur compound, a substituted aromatic amine, a substituted alkyl amine, an ethoxylated branched nonylphenol phosphate, an oxyalkylated derivative, an anionic surfactant, a carboxylic acid derivative, an imidazoline, and any combination thereof.

10. The method of claim 1, wherein the scale inhibitor is selected from the group consisting of an amine phosphonate, ([2-(2-hydroxyethoxy)ethyl-(phosphonomethyl)amino]methylphosphonic acid or a salt thereof, bishexamethylenetriamine pentamethylenepentaphosphonic acid, diethylenetriaminepenta(methylenephosphonic acid) or a salt thereof, a sodium salt of a polyether phosphonomethylated amine, tetrasodium ethylenediaminetetraacetic acid, a maleicic acid polymer with sodium allylsulfonate, a polymer comprising vinylphosphonic acid and vinylsulfonic acid, a maleic acid and olefin polymer or a salt thereof, and any combination thereof.

11. The method of claim 1, wherein the scavenger is selected from the group consisting of a triazine, a reaction product of a hemiacetal and an amine, hexahydro-1,3,5-trimethyl-S-triazine, hexahydro-1,3,5-tris(2-hydroxyethyl)-S-triazine, [nitrilotris(ethyleneoxy)]tri-methanol, methylenebis-methyloxazolidine, a substituted aliphatic aldehyde, glyoxal, 1,2-ethanediylbis(oxy)bismethanol, a substituted alkyl amine and formaldehyde adduct, an oxidant, inorganic peroxide, chlorine dioxide, glutaraldehyde, acrolein, methacrolein, a metal-based scavenger, and any combination thereof.

12. A composition, comprising:
from about 0.1 wt. % to about 90 wt. % of a solvent,
from about 0.1 wt. % to about 90 wt. % of a corrosion inhibitor,
from about 0.1 wt. % to about 90 wt. % of a scale inhibitor, and
from about 0.1 wt. % to about 90 wt. % of a scavenger.

13. The composition of claim 12, wherein the solvent is selected from the group consisting of a polar protic solvent, an alcohol, water, a glycol ether, and any combination thereof.

14. The composition of claim 12, wherein the corrosion inhibitor is selected from the group consisting of N-benzyl-alkylpyridinium chloride, benzyl quinolinium chloride, a fatty acid amine condensate, a quaternary ammonium compound, an organic sulfur compound, a substituted aromatic amine, a substituted alkyl amine, an ethoxylated branched nonylphenol phosphate, an oxyalkylated derivative, an anionic surfactant, a carboxylic acid derivative, an imidazoline, and any combination thereof, and/or wherein the scale inhibitor is selected from the group consisting of an amine phosphonate, ([2-(2-hydroxyethoxy)ethyl-(phosphonomethyl)amino]methylphosphonic acid or a salt thereof, bishexamethylenetriamine pentamethylenepentaphosphonic acid, diethylenetriaminepenta(methylenephosphonic acid) or a salt thereof, a sodium salt of a polyether phosphonomethylated amine, tetrasodium ethylenediaminetetraacetic acid, a maleicic acid polymer with sodium allylsulfonate, a polymer comprising vinylphosphonic acid and vinylsulfonic acid, a maleic acid and olefin polymer or a salt thereof, and any combination thereof.

15. The composition of claim 12, wherein the scavenger is selected from the group consisting of a triazine, a reaction product of a hemiacetal and an amine, hexahydro-1,3,5-trimethyl-S-triazine, hexahydro-1,3,5-tris(2-hydroxyethyl)-S-triazine, [nitrilotris(ethyleneoxy)]tri-methanol, methylenebis-methyloxazolidine, a substituted aliphatic aldehyde, glyoxal, 1,2-ethanediylbis(oxy)bismethanol, a substituted alkyl amine and formaldehyde adduct, an oxidant, inorganic peroxide, chlorine dioxide, glutaraldehyde, acrolein, methacrolein, a metal-based scavenger, and any combination thereof.

16. The composition of claim 12, further comprising from about 5 wt. % to about 20 wt. % of the solvent, about 5 wt. % to about 15 wt. % of the corrosion inhibitor, about 1 wt. % to about 5 wt. % of the scale inhibitor, and/or from about 65 wt. % to about 90 wt. % of the scavenger.

17. The composition of claim 12, further comprising from about 5 wt. % to about 15 wt. % of the solvent, wherein the solvent comprises monoethylene glycol, from about 5 wt. % to about 15 wt. % of the corrosion inhibitor, wherein the corrosion inhibitor comprises a reaction product of tall oil fatty acid with acrylic acid and diethylenetriamine, alkyldimethylbenzyl ammonium chloride, 2-mercaptoethanol, triethanolamine, a phosphoric ester of nonylphenol ethoxylate, nonylphenyl polyethylene glycol, and any combination thereof, from about 1 wt. % to about 5 wt. % of the scale inhibitor, wherein the scale inhibitor is selected from the group consisting of tetrasodium ethylenediaminetetraacetic acid, diethylenetriaminepenta(methylenephosphonic acid) sodium salt, and any combination thereof, and from about 70 wt. % to about 90 wt. % of the scavenger, wherein the scavenger is selected from the group consisting of a reaction product of a hemiacetal and an amine, hexahydro-1,3,5-trimethyl-S-triazine, hexahydro-1,3,5-tris(2-hydroxyethyl)-S-triazine, and any combination thereof.

18. The composition of claim 12, further comprising from about 5 wt. % to about 15 wt. % of the solvent, wherein the solvent comprises monoethylene glycol, from about 5 wt. % to about 15 wt. % of the corrosion inhibitor, wherein the corrosion inhibitor comprises a reaction product of tall oil fatty acid with acrylic acid and diethylenetriamine, alkyldimethylbenzyl ammonium chloride, 2-mercaptoethanol, a phosphoric ester of nonylphenol ethoxylate, an alkyl pyridine, morpholine, dioctyl sodium sulfonsuccinate, and any combination thereof, from about 1 wt. % to about 5 wt. % of the scale inhibitor, wherein the scale inhibitor is selected from the group consisting of [2-(2-hydroxyethoxy)ethyl-(phosphonomethyl)amino]methylphosphonic acid, tetrasodium ethylenediaminetetraacetic acid, diethylenetriaminepenta(methylenephosphonic acid) sodium salt, and any combination thereof, and from about 70 wt. % to about 90 wt. % of the scavenger, wherein the scavenger is selected from the group consisting of a reaction product of a hemiacetal and an amine, hexahydro-1,3,5-trimethyl-S-triazine, hexahydro-1,3,5-tris(2-hydroxyethyl)-S-triazine, and any combination thereof.

19. The composition of claim 12, further comprising from about 10 wt. % to about 20 wt. % of the solvent, wherein the solvent comprises monoethylene glycol, isopropanol, methanol, or any combination thereof, from about 5 wt. % to about 15 wt. % of the corrosion inhibitor, wherein the corrosion inhibitor comprises a reaction product of tall oil fatty acid with acrylic acid and diethylenetriamine, alkyldimethylbenzyl ammonium chloride, 2-mercaptoethanol, triethanolamine, a phosphoric ester of nonylphenol ethoxylate, nonylphenyl polyethylene glycol, and any combination thereof, from about 1 wt. % to about 5 wt. % of the scale inhibitor, wherein the scale inhibitor is selected from the group consisting of tetrasodium ethylenediaminetetraacetic acid, diethylenetriaminepenta(methylenephosphonic acid) sodium salt, and any combination thereof, and from about 65 wt. % to about 75 wt. % of the scavenger, wherein the scavenger is selected from the group consisting of a reaction product of a hemiacetal and an amine.

20. The composition of claim 12, further comprising from about 5 wt. % to about 10 wt. % of the monoethylene glycol, from about 2 wt. % to about 4 wt. % of the reaction product of tall oil fatty acid with acrylic acid and diethylenetriamine, from about 1 wt. % to about 3 wt. % of the alkyldimethylbenzyl ammonium chloride, from about 0.5 wt. % to about 2 wt. % of the 2-mercaptoethanol, from about 1 wt. % to about 3 wt. % of the triethanolamine, from about 0.5 wt. % to about 2 wt. % of the phosphoric ester of nonylphenol ethoxylate, from about 0.5 wt. % to about 2 wt. % of the nonylphenyl polyethylene glycol, from about 0.5 wt. % to about 1.5 wt. % of the tetrasodium ethylenediaminetetraacetic acid, from about 2 wt. % to about 4 wt. % of the diethylenetriaminepenta(methylenephosphonic acid) sodium salt, and from about 75 wt. % to about 85 wt. % of the reaction product of the hemiacetal and the amine.
